(19) United States
(12) Patent Application Publication
(10) Pub. No.: US 2008/0208705 A1
(43) Pub. Date: Aug. 28, 2008

(54) PERSONALIZED SHOPPING ASSISTANT

(75) Inventors: Mary Rossick Kern, Castle Rock, CO (US); Ismail S. Abbass, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Interactive Luxury Solutions LLC, Denver, CO (US)

(21) Appl. No.: 11/828,207

(22) Filed: Jul. 25, 2007

Related U.S. Application Data
(60) Provisional application No. 60/891,445, filed on Feb. 23, 2007.

(51) Int. Cl. G06Q 30/00

(52) U.S. Cl. 705/26

(57) ABSTRACT

Methods and systems of providing purchasing suggestions to a shopper are disclosed. Data are maintained representing one or more profiles of individuals. Each such profile includes a plurality of fields descriptive of qualities of one of the individuals. A request is received over a public network from the shopper to provide a purchasing suggestion for a recipient. A level of correlation is evaluated between aspects of each of a plurality of products with the qualities of the recipient according to the profile of the recipient. A list of products having the level of correlation exceed a defined threshold value is generated. The list is provided to the shopper.

### CROSS-REFERENCES TO RELATED APPLICATIONS

This application is a nonprovisional of, and claims the benefit of the filing date of, U.S. Prov. Pat. Appl. No. 60/891,445, entitled “PERSONALIZED SHOPPING ASSISTANT,” filed Feb. 23, 2007 by Mary Rossick Kern and Ismail S Abbass, the entire disclosure of which is incorporated herein by reference for all purposes.

### BACKGROUND OF THE INVENTION

This application relates generally to electronic commerce. More specifically, this application relates to methods and systems of providing a personalized shopping assistant to aid in electronic commerce.

In the years since the introduction of the Internet, one of its most useful functions has been to provide a convenient mechanism for making purchases. Indeed, the use of electronic commerce has steadily increased and continues to increase in popularity. The main reasons for such popularity are the convenience that the Internet offers to consumers to review offerings of various products from the convenience of their homes or offices and the ability to arrange for direct delivery of goods. A significant time benefit is provided to consumers in being able to conduct transactions without needing to visit stores physically. And the various search engines provided on the Internet generally makes it easier for consumers to identify the specific products they wish to purchase, frequently avoiding the need to make physical visits to merchants to review and evaluate products being considered.

But even with these benefits, there remain certain fundamental aspects to the shopping experience that can cause frustration for consumers. One of these is the difficulty in identifying suitable gifts for recipients. Consumers frequently wish to purchase a gift for a particular recipient and wish to purchase one that the recipient is likely to appreciate and enjoy, but are uncertain about how to go about identifying such a gift. Various tools that exist as an aid to electronic commerce do not directly address this difficulty.

For example, a common practice currently allows consumers to generate “wish lists” of specific gifts they would like to receive. This allows purchasers to review the lists generated by a particular recipient and to select one of the items. But many purchasers dislike the impersonal nature of simply buying an object that the recipient has requested, preferring to identify something independently that the recipient will enjoy. Other tools monitor purchases made by individuals and use correlation algorithms to identify the age and preferences of the individuals. This may provide some guidance to a consumer of the general category of goods and services that the recipient might enjoy, but lacks specificity.

There is accordingly a need in the art for improved methods and systems of aiding product selections in electronic commerce.

### BRIEF SUMMARY OF THE INVENTION

Embodiments of the invention thus provide methods of providing purchasing suggestions to a shopper. Data are maintained representing one or more profiles of individuals. Each such profile includes a plurality of fields descriptive of qualities of one of the individuals. A request is received over a public network from the shopper to provide a purchasing suggestion for a recipient. A level of correlation is evaluated between aspects of each of a plurality of products with the qualities of the recipient according to the profile of the recipient. A list of products having the level of correlation exceed a defined threshold value is generated. The list is provided to the shopper.

In different embodiments, the qualities of the individuals comprise demographic information, interests and/or tastes of the individuals, and/or indications of price ranges for shopping recommendations. The profile of the recipient may sometimes comprise an identification of one or more excluded aspects, with the list being generated by excluding products having any of the excluded aspects. In other instances, at least some of the qualities comprised by the recipient's profile are associated with a weighting factor so that evaluating the level of correlation comprises weighting those qualities with the weighting factor.

Certain embodiments of the invention also make use of rating. For example, at least some of the products comprised by the generated list may be associated with ratings derived from feedback information provided by other shoppers; in such instances, the ratings may be provided to the shopper with the list. An evaluation may accordingly be received from the shopper for a selected one of the products that indicates a level of acceptability of the selected one of the products to the recipient, permitting the rating for the selected one of the products to be modified in accordance with the evaluation. In some cases, a plurality of merchant sites may be searched using the public network to identify at least some of the products.

In some instances, a selection of a product on the list is received from the shopper so that a purchase request for the product may be initiated on behalf of the shopper using stored financial-account information. There are also embodiments in which the request from the shopper includes an override of a quality of the recipient. In such embodiments, evaluating the level of correlation between aspects of each of the plurality of products with the qualities of the recipient is modified by the override.

The recipient may sometimes also be the shopper. There are also embodiments in which the shopper is one of a plurality of shoppers having access to the profile of the recipient over the public network. The profile of the recipient may be generated at least in part by the recipient, by the shopper, or by someone who is neither the shopper nor the recipient.

Methods of the invention may also be embodied by a computer-readable storage medium having a computer-readable program embodied therein for directing operation of a personal-shopping-assistant computer, which may include a communications system, a processor, and a storage device. The computer-readable program includes instructions for operating the personal-shopping-assistant computer to implement the methods as described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 provides a schematic overview of an architecture for electronic commerce within which the invention may be embodied;

FIG. 2 provides a schematic illustration of a computational structure that may be used to implement the personal-shopping-assistant computer;

FIG. 3 is a flow diagram that summarizes methods in accordance with embodiments of the invention to establish profiles used by the personal-shopping-assistant computer;

FIG. 4 provides an example of screen that may be used to enter or review profile information; and

FIG. 5 is a flow diagram that summarizes methods in accordance with embodiments of the invention for using the personal-shopping-assistant computer.

### DETAILED DESCRIPTION OF THE INVENTION

Embodiments of the invention make use of profile information for gift recipients to make recommendations for purchases, perhaps in accordance with certain filtering criteria imposed by the purchaser. In some embodiments, execution of the purchase transaction may also be automated, generally simplifying the process by which consumers may effect a variety of gift purchases.

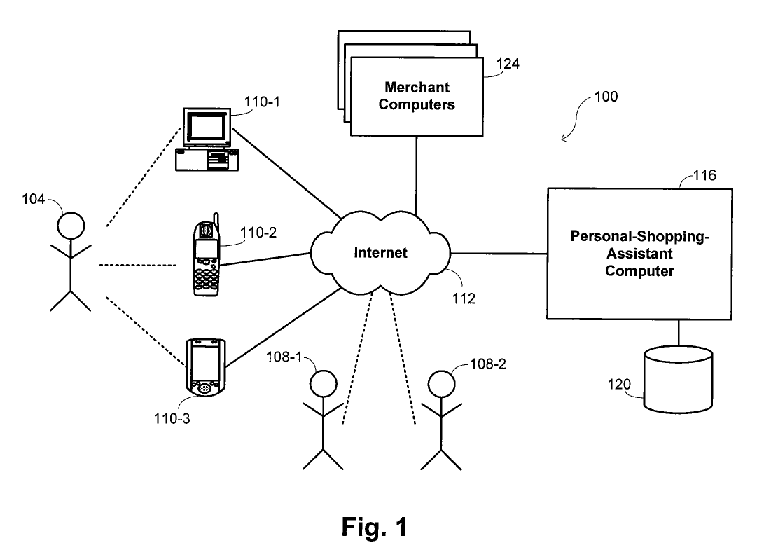

A general architecture within which embodiments of the invention may be implemented is shown schematically in FIG. 1. This architecture 100 makes use of a public network such as the Internet 112 to effect communications between at least a consumer 104 and a personal-shopping-assistant computer. The consumer 104 may interface with the Internet 112 using any Internet-enabled device 110. The drawing shows a personal computer 110-1, cellular telephone 110-2, and a personal digital assistant 110-3 as examples of Internet-enabled devices that may be used in different embodiments, but this is not intended to be restrictive; more generally, any Internet-enabled device may be used. Communications may also be effected with the Internet 112 by other parties 108 using similar kinds of devices that are not explicitly shown in the drawing. In some instances, such other parties 108 may comprise potential gift recipients.

There are a number of different reasons why such recipients might use access to the Internet 112, although such access is not required in all implementations of the invention. For example, a gift that is purchased might be such that it requires an Internet connection to make use of the service; this might be the case where the gift comprises a subscription to a video-on-demand service, comprises an electronic gift certificate to an online merchant, comprises access to an Internet-based game, or some other such gift. In cases where a gift is a physical item that may be delivered to the recipient, it is possible for recipients to participate without having any Internet connection. There are also embodiments described below in which a recipient may interact directly with the personal-shopping-assistant computer 116, such as by providing information that is included in his or her profile.

There are at least two distinct techniques that may be used by the personal-shopping-assistant computer 116 in identifying potential gift suggestions. First, a data store 120 provided in communication with the personal-shopping-assistant computer may store information about products and how they are classified according to criteria used in making suggestions. This data store may also be used to store the profiles, or different data sources may be used for storage of profile information and for storage of product information. Second, the personal-shopping-assistant computer 116 may use connections with merchant computers 124 through the Internet 112 to initiate searches of products offered on such web sites. This may involve the use of a web robot having sufficient software to apply filtering criteria used in identifying products that satisfy the criteria specified in the recipient's profile.

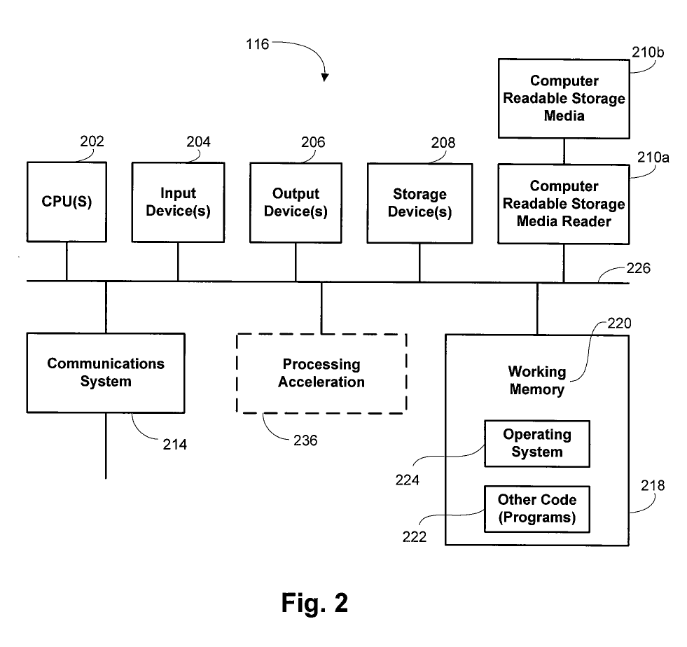

FIG. 2 provides a schematic illustration of a structure of the personal-shopping-assistant computer 116 that may be used to implement embodiments of the invention. FIG. 2 broadly illustrates how individual system elements may be implemented in a separated or more integrated manner. The computer 116 is shown comprised of hardware elements that are electrically coupled via bus 226, including a processor 202, an input device 204, an output device 206, a storage device 208, a computer-readable storage media reader 210a, a communications system 214, a processing acceleration unit 216 such as a DSP or special-purpose processor, and a memory 218. The storage device 208 may, in some instances, correspond to the data store 120, but may alternatively comprise a device separate from the data store 120. The computer-readable storage media reader 210a is further connected to a computer-readable storage medium 210b, the combination comprehensively representing remote, local, fixed, and/or removable storage devices plus storage media for temporarily and/or more permanently containing computer-readable information. The communications system 214 may comprise a wired, wireless, modem, and/or other type of interfacing connection and permits data to be exchanged with the Internet 112 to implement embodiments as described herein.

The computer 116 also comprises software elements, shown as being currently located within working memory 220, including an operating system 224 and other code 222, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

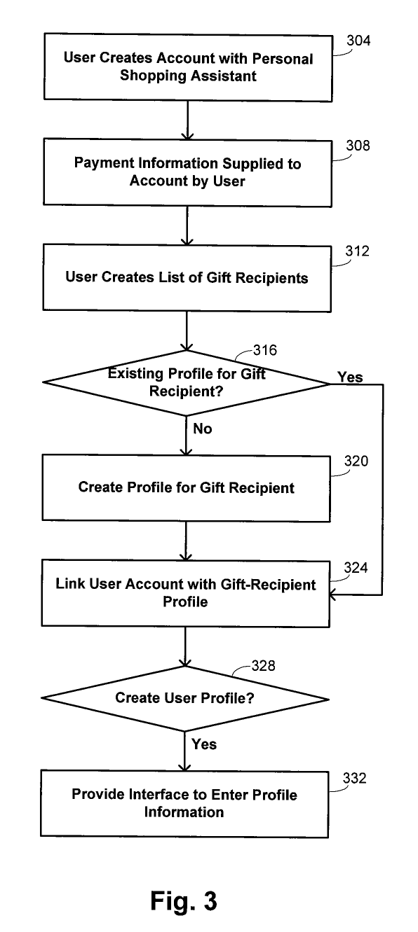

FIG. 3 is a flow diagram that provides a general overview of how a profile may be created and linked with a particular potential gift recipient using the architecture described in connection with FIG. 1. The method begins generally with a user of the service connecting with the personal-shopping-assistant computer 116 over the Internet 112 and creating an account at block 304. Creation of an account may involve supplying such identification information as a name and address, email account address, telephone number, and the like. In addition, payment information may be supplied to the account by the user at block 308. When supplied, such payment information will generally include sufficient financial-account information that the personal-shopping-assistant computer will be capable of entering into financial transactions merely upon receipt of approval from the user. For example, a credit-card number could be supplied with additional identification information such as an expiration date and a three- or four-digit verification number that is often printed on the reverse of a credit card. Alternatively, debit-card information could be supplied or information identifying an online account service such as Paypal® or StormPay.com could be supplied.

Once an account has been established, the user may create a list of potential gift recipients at block 312. There are a number of different mechanisms by which profiles for gift recipients may be managed. For instance, in some embodiments, the profile for each gift recipient is unique to the user. That is, in such embodiments, even if multiple users identify the same gift recipient, each user will have a separate profile for that recipient so that the profiles may differ from user to user. In other embodiments, though, the profile for common gift recipients may be shared. Such sharing has the advantage that information garnered by one user may be applied by another user in generating personal-shopping recommendations. In certain implementations, the user may be given a choice for each user that is registered whether to use a common profile or to limit shopping recommendations to being derived from that user's unique profile for that recipient. Furthermore, in some instances, the profile information for a particular recipient may be generated in whole or in part by the recipient himself. This is a feature that may be included when users of the system are also potential gift recipients of other users. Such an arrangement is discussed in further detail below.

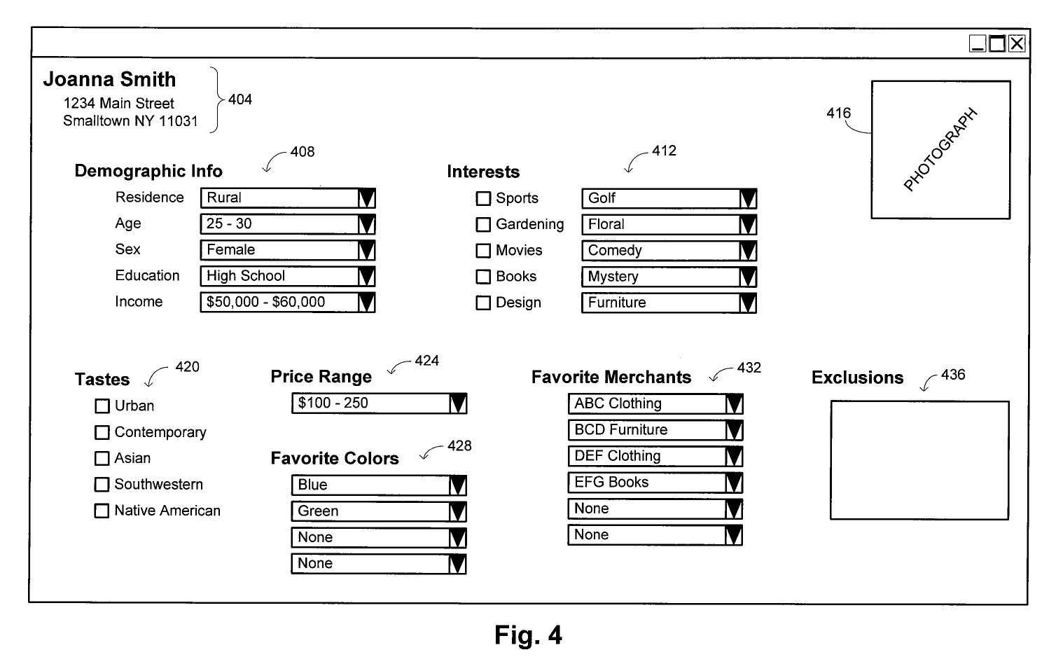

Block 316 of the drawing thus checks whether a profile already exists for each gift recipient identified by the user in creating the list of gift recipients at block 312. If not, or if the user decides to generate a unique profile and not to use a common profile, a profile is created by the system at block 320. Creation of such a profile may proceed in a number of different ways using different kinds of interfaces with the user. A convenient mechanism for generating the profile makes use of a set of fields displayed graphically to the user that can be populated with relevant profile information. An example of such a set of fields is provided in FIG. 4, certain details of which are discussed further below. Once a suitable profile exists, the user account is linked with the gift-recipient profile at block 324.

As intimated above, in some embodiments, the user may also create a profile. This allows the user to enter information about himself that may be used in generating purchase recommendations for others who use the system. In some respects, this may advantageously allow the profile information to be more accurately reflective of the recipient. It will generally not be the case that the user is required to generate a profile, with the system more usually providing an option as indicated at block 328 whether the user wishes to create a profile. If so, an interface is provided at block 332 similar to the interface provided at block 320 for the user to enter profile information. Once the user profile is created, other users of the system may be able to link their own accounts to it when seeking the help of the personal-shopping-assistant computer 120 in generating recommendations. A mechanism may also be provided to edit the profile information, either by users who have linked their accounts to the profile or by the recipient depending on the embodiment actually being implemented.

One example of an interface that may be used in some embodiments is shown in FIG. 4 This is presented as a screen shot of a typical profile that includes a combination of check boxes and drop-down menus to enter a variety of kinds of information that may be used in generating recommendations. In other embodiments, the profile interface may take different forms. Information included in the profile generally comprises an identification of the recipient 404 and perhaps a photograph of the recipient 416.

The profile information that is available to be used in generating gift recommendations may include demographic information 408, an identification of the recipient's interests 412, an identification of the recipient's interests 412, an identification of the recipient's tastes 420, in identification of a suitable price range 424 for a gift, an identification of the recipient's favorite colors 428, an identification of the recipient's favorite merchants 432, and so on.

Demographic information 408 may include such things as an identification of the nature of the recipient's residence location, an age range for the recipient, the recipient's sex, the education level achieved by the recipient, the annual income of the recipient, and other such demographic factors. Examples of interests 412 that might be used in generating gift recommendations are included on the drawing, and it is generally expected that multiple such interest categories may be selected by using a combination of check boxes to identify categories of interests and drop-down menus that provide more specificity of the nature of each interest. Check boxes may similarly be used to identify tastes 420 of the recipient so that multiple tastes may be identified. The use of check boxes in this manner generally affords each interest and each taste that is identified the same weight. But in other embodiments, different weighting factors could be assigned to such qualities by using a numerical scheme, such as one in which the person uses a 1 to indicate the quality is of low weight, a 10 to indicate the quality is of high weight, and intermediate numbers indicating intermediate weights for the quality.

In addition to specifying these various qualities, certain embodiments of the invention also permit exclusions 436 to be specified. Such exclusions act to suppress certain recommendations that might otherwise be made by identifying types of merchandise, merchants, colors, brands, or other qualities that are likely not to be well received by the recipient. It is otherwise possible that a recommendation might be generated that meets various of the preferences identified in the profile but is undesirable because of some other quality. The override provided by the identified exclusions 436 avoids such a result.

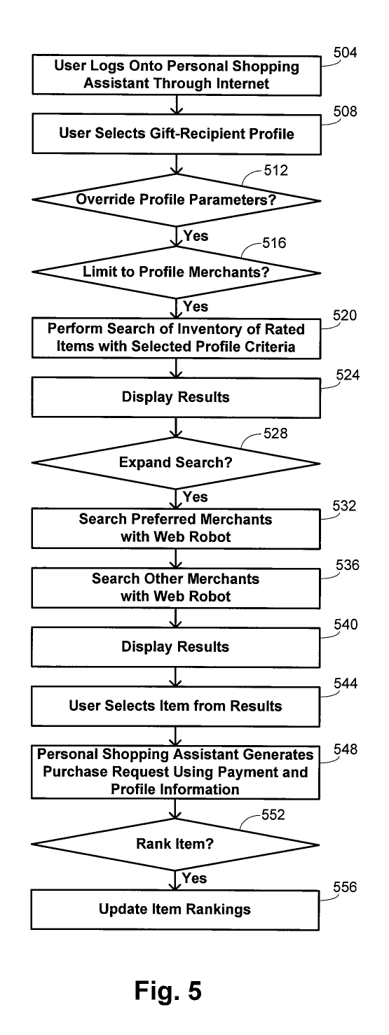

Once a profile has been established for a particular recipient, the system may be used to generate gift recommendations for that recipient. One such method is summarized with the flow diagram of FIG. 5. While this flow diagram sets forth a number of specific steps and indicates a particular order for performing the steps, this is not intended to be limiting. In various alternative embodiments, some of the steps may be omitted, additional steps not indicated explicitly may be performed and/or the order of the steps may be changed. Selection of a gift may begin at block 504 with the user logging onto the personal shopping assistant through the Internet. The user selects the profile for the particular recipient from the list of recipients linked to the user's account at block 508.

In some embodiments, an option may be provided to override certain parameters of the profile. This is similar in operation to the exclusions discussed above, but the exclusions are a more permanent feature of the profile that prevent recommendations falling into excluded categories from ever being provided. The override option at block 512 allows individual overrides to be applied to an individual recommendation session without necessarily applying to other recommendation sessions. This allows the recommendations to be tailored for a particular gift to reflect particular circumstances or events. In addition, an option may be provided to limit the recommendations to the preferred merchants identified in the profile at block 516. In different implementations of the invention, the merchants from whom products included in the recommendations are supplied may be tailored in a manner similar to the override provisions. If the merchants are limited at block 516, recommendations will be provided only for products supplied by merchants identified in the recipient's profile; otherwise, the recommendations may be more expansive and include products from other merchants also.

Once the criteria for developing recommendations have been thus defined, a search is performed for suitable products at block 520. This may initially take place by searching an inventory of items maintained by the personal-shopping-assistant computer 120. In particular, the search may be made against items that have been rated by other users for how well they were received by recipients having similar profile criteria. Such information may be helpful to the user in making a final selection. There are a variety of statistical methods known to those of skill in the art that may be used to assess the similarity of profiles and to derive appropriately weighted rankings of recommended items based on the ratings provided by other users.

The search of inventory items to identify those products that are to be recommended may also make use of a variety of different statistical techniques known to those of skill in the art. For example, correlation functions relating the similarity of the product to qualities specified in the recipient's profile may be used to derive ratings that indicate the likely acceptability of the item to the recipient. In some instances, the availability of rating information by other users permits the system to be adaptive by changing the rankings based on new information that is received. Certain artificial-intelligence techniques may be used in different embodiments of the invention to implement such adaptability. For example, a neural network may be established in which input nodes define combinations of qualities that appear in different profiles and output nodes define appropriate ratings for particular products. A set of intermediate nodes in the neural network may have its interconnections with the input and output nodes modified in response to receipt of additional rating information to improve the usefulness of future ratings. Other artificial-intelligence techniques that may be used include the use of expert systems, the use of genetic algorithms, and the use of thermal-annealing techniques, all of which are familiar to those of skill in the art.

The results of the search are displayed at block 524, permitting the user to select one or more of the items for purchase. In some instances, the user may find that none of the recommendations appears to be suitable and may wish to expand the scope of the search. One method by which the search may be expanded is to extend the search beyond the stored inventory of items. Thus, if a decision is made at block 528 to expand the search, products provided by the preferred merchants at their web sites may be searched at block 532. This may be done by using a web robot implemented by the personal-shopping-assistant computer 120 that is configured to check the relevant web sites and to apply the selection criteria defined by the recipient's profile, as indicated at block 532. A still more expansive search may be performed at block 536 by performing a similar process with the web robot with additional merchants that are not identified by the profile as preferred by the recipient.

In cases where a search is performed by a web robot, the potential selections might not benefit from rating information provided by other users of the system, but it is still possible to apply known statistical techniques to rank the results according to how closely that relate to the profile information, particularly if the profile information includes preference scores as described above for some embodiments.

Once the results have been generated in this way, they are displayed to the user at block 540, permitting the user to make a selection of one of the results at block 544. The personal-shopping-assistant computer 120 may effect the actual transaction embodiments where the user has provided payment information associated with his account. In such instances, the user may be asked to confirm a desire to proceed with the transaction, with the personal-shopping-assistant computer 120 then supplying the payment and other information directly to the merchant and confirming all steps needed to complete the transaction. Such embodiments provide additional convenience to the user by simplifying the payment process, irrespective of who the supplying merchant is.

The user may additionally be given an opportunity to rank the success of the item as a gift at block 552, usually after the gift recipient has received the item. Such rankings may use a simple numerical scale to indicate how well received the item was. For instance, a ranking of 1 might mean that the gift was not well received, a ranking of 10 might indicate that the gift was extremely well received, and intermediate numerical values may give an indication of the success of the item in nonextreme cases. This information is used at block 556 to update the stored rankings of items so that they may later be available to other users of the system in understanding how desirable the gift may be to other recipients having similar profile information.

It is generally expected that various aspects of the organizational structure used by the system in different embodiments will provide different levels of flexibility. For example, a very flexible system might allow a single recipient profile to be linked by multiple users, all of whom might be able to edit information in the profile to produce as accurate a representation of the relevant qualities of the recipient as possible. When those profiles include nonuniform prioritization indicators, the ability to match items against the profile is likely to be more successful. In addition, the use of rankings that indicate the success of individual items as gifts may be useful to other users in discriminating among what has the potential to be a large number of potential gift suggestions. Moreover, when the system allows a user to enter a profile, it becomes possible for the user to obtain personalized shopping recommendations for himself by identifying himself as the gift recipient. When used in combination with various filtering techniques, the system thus has the potential to aid users in finding particular types of products that the user is likely to be interested in.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method of providing purchasing suggestions to a shopper, the method comprising:
maintaining data representing one or more profiles of individuals, each such profile including a plurality of fields descriptive of qualities of one of the individuals;
receiving over a public network a request from the shopper to provide a purchasing suggestion for a recipient;
evaluating a level of correlation between aspects of each of a plurality of products with the qualities of the recipient according to the profile of the recipient;
generating a list of products having the level of correlation exceed a defined threshold value; and
providing the list to the shopper.

2. The method recited in claim 1 wherein the qualities of the individuals comprise demographic information.

3. The method recited in claim 1 wherein the qualities of the individuals comprise interests and/or tastes of the individuals.

4. The method recited in claim 1 wherein the qualities of the individuals comprise indications of price ranges for shopping recommendations.

5. The method recited in claim 1 wherein:
the profile of the recipient comprises an identification of one or more excluded aspects; and
generating the list comprises excluding products having any of the excluded aspects from the list.

6. The method recited in claim 1 wherein:
at least some of the qualities comprised by the profile of the recipient are associated with a weighting factor; and
evaluating the level of correlation comprises weighting the at least some of the qualities with the weighting factor.

7. The method recited in claim 1 wherein:
at least some of the products comprised by the generated list are associated with ratings derived from feedback information provided by other shoppers; and
providing the list to the shopper comprises providing the ratings to the shopper.

8. The method recited in claim 7 further comprising:
receiving an evaluation from the shopper for a selected one of the products that indicates a level of acceptability of the selected one of the products to the recipient; and
modifying the rating for the selected one of the products in accordance with the evaluation.

9. The method recited in claim 1 wherein evaluating the level of correlation between aspects of a plurality of products with the qualities of the recipient comprises searching a plurality of merchant sites using the public network to identify at least some of the plurality of products.

10. The method recited in claim 1 further comprising:
receiving a selection of a product on the list from the shopper; and
initiating a purchase request for the product on behalf of the shopper using stored financial-account information of the shopper.

11. The method recited in claim 1 wherein the recipient is the shopper.

12. The method recited in claim 1 wherein:
the request from the shopper includes an override of a quality of the recipient; and
evaluating the level of correlation between aspects of each of the plurality of products with the qualities of the recipient comprises evaluating the level of correlation between aspects of each of the plurality of products with the qualities of the recipient according to the profile of the recipient and modified by the override.

13. The method recited in claim 1 wherein the shopper is one of a plurality of shoppers having access to the profile of the recipient over the public network.

14. The method recited in claim 1 wherein the profile of the recipient was generated at least in part by the recipient.

15. The method recited in claim 1 wherein the profile of the recipient was generated at least in part by the shopper.

16. The method recited in claim 1 wherein the profile of the recipient was generated at least in part by someone who is neither the shopper nor the recipient.

17. A computer-readable storage medium having a computer-readable program embodied therein for directing operation of a personal-shopping-assistant computer including a communications system, a processor, and a storage device, wherein the computer-readable program includes:
instructions for maintaining data on the storage device, the data representing one or more profiles of individuals, each such profile including a plurality of fields descriptive of qualities of one of the individuals;
instructions for receiving over a network using the communications system a request from the shopper to provide a purchasing suggestion for a recipient;
instructions for evaluating with the processor a level of correlation between aspects of each of a plurality of products with the qualities of the recipient according to the profile of the recipient;
instructions for generating with the processor a list of products having the level of correlation exceed a defined threshold value; and
instructions for providing the list to the shopper using the communications system.

18. The system recited in claim 17 wherein the qualities of the individual comprise demographic information.

19. The system recited in claim 17 wherein the qualities of the individuals comprise interests and/or tastes of the individuals.

20. The system recited in claim 17 wherein the qualities of the individuals comprise indications of price ranges for shopping recommendations.

21. The system recited in claim 17 wherein:
the profile of the recipient comprises an identification of one or more excluded aspects; and
generating the list comprises excluding products having any of the excluded aspects from the list.

22. The system recited in claim 17 wherein:
at least some of the qualities comprised by the profile of the recipient is associated with a weighting factor; and
evaluating the level of correlation comprises weighting the at least some of the qualities with the weighting factor.

23. The system recited in claim 17 wherein:
at least some of the products comprised by the generated list are associated with ratings derived from feedback information provided by other shoppers; and
the instructions for providing the list to the shopper comprises instructions for providing the ratings to the shopper.

24. The system recited in claim 22 wherein the computer-readable program further includes:
instructions for receiving with the communications system an evaluation from the shopper for a selected one of the products that indicates a level of acceptability of the selected one of the products to the recipient; and
instructions for modifying with the rating for the selected one of the products in accordance with the evaluation.

25. The system recited in claim 17 wherein the instructions for evaluating the level of correlation between aspects of a plurality of products with the qualities of the recipient comprises instructions for searching a plurality of merchant sites using the public network to identify at least some of the plurality of products.

26. The system recited in claim 17 wherein the computer-readable program further includes:
instructions for receiving with the communications system a selection of a product on the list from the shopper; and
instructions for initiating a purchase request for the product on behalf of the shopper using financial-account information of the shopper stored on the storage device.

27. The system recited in claim 17 wherein the recipient is the shopper.

28. The system recited in claim 17 wherein;
the request from the shopper includes an override of a quality of the recipient; and
the instructions for evaluating the level of correlation between aspects of each of the plurality of products with the qualities of the recipient comprises instructions for evaluating the level of correlation between aspects of each of the plurality of products with the qualities of the recipient according to the profile of the recipient and modified by the override.

29. The system recited in claim 17 wherein the shopper is one of a plurality of shoppers having access to the profile of the recipient over the public network.

30. The system recited in claim 17 wherein the profile of the recipient was generated at least in part by the recipient.

31. The system recited in claim 17 wherein the profile of the recipient was generated at least in part by the shopper.

32. The system recited in claim 17 wherein the profile of the recipient was generated at least in part by someone who is neither the shopper nor the recipient.
